(19) United States
(12) Patent Application Publication
(10) Pub. No.: US 2023/0120781 A1
(43) Pub. Date: Apr. 20, 2023

(54) SYSTEMS, APPARATUSES, AND METHODS FOR CALIBRATING LIDAR SENSORS OF A ROBOT USING INTERSECTING LIDAR SENSORS

(71) Applicant: Brain Corporation, San Diego, CA (US)

(72) Inventor: Ryan Lustig, San Diego, CA (US)

(21) Appl. No.: 18/084,145

(22) Filed: Dec. 19, 2022

Related U.S. Application Data
(63) Continuation of application No. PCT/US21/39688, filed on Jun. 29, 2021.
(60) Provisional application No. 63/045,427, filed on Jun. 29, 2020.

(51) Int. Cl. G01S 7/497; G01S 17/93; B25J 9/16

(52) U.S. Cl. CPC G01S 7/497; B25J 9/1694; G01S 17/93

(57) ABSTRACT

Systems, apparatuses, and methods for calibrating LiDAR sensors of a robot using intersecting LiDAR sensors are disclosed herein. According to at least one non-limiting exemplary embodiment, a robot may calibrate a calibration LiDAR based on a determined pose of the calibration LiDAR, wherein the pose is determined based on a measurement error between the calibration LiDAR and an intersecting reference LiDAR.

### PRIORITY

This application is a continuation of International Patent Application No. PCT/US21/39688 filed on Jun. 29, 2021 and claims the benefit of U.S. Provisional Pat. Application Serial No. 63/045,427 filed on Jun. 29, 2020 under 35 U.S.C. § 119, the entire disclosure of each is incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

The present disclosure provides, inter alia, systems and methods for calibrating LiDAR sensors of a robot using intersecting LiDAR sensors. The present application relates generally to robotics, and more specifically to systems, apparatuses, and methods for calibrating LiDAR sensors of a robot using intersecting LiDAR sensors.

Exemplary embodiments described herein have innovative features, no single one of which is indispensable or solely responsible for their desirable attributes. Without limiting the scope of the claims, some of the advantageous features will now be summarized.

According to at least one non-limiting exemplary embodiment, a non-transitory, computer-readable memory comprising a plurality of instructions stored thereon is disclosed. The non-transitory, computer-readable memory comprises instructions to a processor that is specially programmed and configured to collect groups of scans comprising scan data from a calibration LiDAR and a reference LiDAR, the calibration LiDAR being a LiDAR sensor in need of calibration and the reference LiDAR being a well-calibrated LiDAR sensor; determine a pose of the calibration LiDAR based on the scan data within the groups; and adjust data or mountings of the calibration LiDAR based on the determined pose of the calibration LiDAR. The computer-readable instructions may further configure the processor to impose a selection threshold to ensure measurements used to determine an intersection between the calibration LiDAR and reference LiDAR lies within a substantially flat surface orthogonal to a measurement plane of the reference LiDAR. Additionally, the computer-readable instructions may further configure the processor to discard any determined poses not meeting a specification threshold, wherein the discarded poses may comprise improbable poses of the calibration LiDAR based on physical constraints.

According to at least one non-limiting exemplary embodiment, a method is disclosed. The method comprises a controller of a robot: collecting a group of scans using a calibration LiDAR and a reference LiDAR, the group of scans comprising a plurality of scans of a surface from both the calibration LiDAR and reference LiDAR; determining a pose of the calibration LiDAR based on the group of scans; and adjusting the calibration LiDAR based on an average pose, the average pose determined based on an average of a plurality of determined poses of the calibration LiDAR, wherein at least one measurement plane of the calibration LiDAR and reference LiDAR intersect upon the surface.

According to at least one non-limiting exemplary embodiment, the method further comprises the controller: imposing a selection threshold orthogonal to a measurement plane of the reference LiDAR; and imposing a specification threshold to determine if a determined pose comprises a good pose or a desirable pose, wherein the good pose or the desirable pose being based on a specification threshold.

According to at least one non-limiting exemplary embodiment, the method further comprises the controller: discarding a scan from the group of scans if the surface is non-flat within the selection threshold.

According to at least one non-limiting exemplary embodiment, the method further comprises the controller: determining the pose of the calibration LiDAR based on minimizing an error measurement calculation, the minimizing being performed via at least one of rotating and translating scans of the group of scans about the origin of the calibration LiDAR.

According to at least one non-limiting exemplary embodiment, the method further comprises the controller: collecting a new group of scans upon the robot detecting a different surface using the calibration LiDAR and reference LiDAR; and updating the average pose based upon the new group of scans of the different surface.

According to at least one non-limiting exemplary embodiment, a system is disclosed. The system comprises: a non-transitory, computer-readable storage medium comprising a plurality of instructions embodied thereon; and a controller configured to execute the computer-readable instructions to: receive a first measurement of a reference surface using a first LiDAR, the first measurement comprising a plurality of points; receive a second measurement of the reference surface using a second LiDAR, the second measurement comprising a plurality of points; select points of the second measurement within a selection threshold, the selection threshold comprising a spatial range orthogonal to measurement plane of the first LiDAR; determine a first spatial transformation between selected points of the second measurement and points of the first measurement, the first spatial transformation configures the second LiDAR to localize the reference surface in a same location as the first LiDAR; determine a pose of the second LiDAR based on the first spatial transformation; and apply a digital filter to data arriving from the second LiDAR, the digital filter being based on the first spatial transformation; wherein, the determining the first spatial transformation is based on minimization of an error, the error comprising a Euclidian distance measurement between points of the second measurement and respective at least one closest point of the first measurement, the reference surface is substantially orthogonal to a measurement plane of the first LiDAR, and the first measurement and the second measurement are formed by grouping a number of individual scans from the respective first and second LiDARs, the number of individual scans being based on a group threshold.

According to at least one non-limiting exemplary embodiment, the system further comprises instructions which, when executed, cause the controller to: calculate the pose of the second LiDAR upon subsequent measurement of the reference surface; and calculate the pose of the second LiDAR upon subsequent measurement of surfaces substantially orthogonal to the measurement plane of the first LiDAR.

According to at least one non-limiting exemplary embodiment, the system further comprises instructions which, when executed, cause the controller to: discard the number of individual scans and start collecting additional scans upon navigating near a new surface if the number of scans of the new surface does not exceed the minimum.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a,” “an,” and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a main robot in accordance with some exemplary embodiments of this disclosure.

FIG. 1B is a functional block diagram of a controller or processor in accordance with some exemplary embodiments of this disclosure.

FIG. 2(i)-(ii) are a light detection and ranging (LiDAR) sensor and features thereof in accordance with some exemplary embodiments of this disclosure.

FIG. 3 is a side view of a robot collecting measurements from a calibration LiDAR and a reference LiDAR at an instance in time, according to an exemplary embodiment.

FIG. 4A(i)-(iii) are a top view of a robot collecting measurements from a calibration LiDAR and a reference LiDAR to illustrate localization errors between the two LiDAR sensors, according to exemplary embodiments.

FIG. 4B is a top view of a robot collecting measurements from a calibration LiDAR and a reference LiDAR to illustrate a calibrated calibration LiDAR sensor generating a minimized error measurement, according to an exemplary embodiment.

FIG. 5 is a data table comprising a plurality of calibration LiDAR measurements and reference LiDAR measurements used to determine an error measurement, according to an exemplary embodiment.

FIG. 6 is a process flow diagram illustrating a method for updating an average pose used to calibrate a calibration LiDAR, according to an exemplary embodiment.

FIG. 7 is a process flow diagram illustrating a method for determining a pose of a calibration LiDAR using data from a group of scans, according to an exemplary embodiment.

FIGS. 8A-B illustrate a system configured to determine an average pose based on individual scans of a calibration LiDAR and reference LiDAR to be used to calibrate the calibration LiDAR, according to an exemplary embodiment.

FIG. 9 is a top view of a robot navigating nearby surfaces to collect scan data to be used to determine a pose of a calibration LiDAR, according to an exemplary embodiment.

All Figures disclosed herein are © Copyright 2020 Brain Corporation. All rights reserved.

### DETAILED DESCRIPTION

Currently, robots may comprise a plurality of light detection and ranging (LiDAR) sensors configured to collect distance measurements between a LiDAR sensor and nearby objects. Each of these LiDAR sensors may be mounted on a robot at a pose determined by the manufacturer of the robot. Often, some LiDAR sensors of a robot may intersect to provide a robot with ample coverage of its surroundings.

Over time, these LiDAR sensors may shift their pose due to a plurality of factors causing the LiDAR sensors to become un-calibrated. Un-calibrated LiDAR sensors may impede the ability of a robot to perform functions and navigate its surrounding environment accurately. An operator may be required to individually calibrate each LiDAR sensor if the LiDAR sensors become un-calibrated.

Accordingly, there is a need in the art for systems and methods for calibrating LiDAR sensors of a robot using intersecting LiDAR sensors as these systems and methods may enable a robot to calibrate its own LiDAR sensors without the need for a human operator that is either in physical proximity to the robot or manipulating and controlling the same over a network from a different location.

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for improved systems and methods for calibrating LiDAR sensors of a robot using intersecting LiDAR sensors.

As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, scooters, self-balancing vehicles such as manufactured by Segway, etc.), trailer movers, vehicles, and the like. Robots may also include any autonomous and/or semi-autonomous machine for transporting items, people, animals, cargo, freight, objects, luggage, and/or anything desirable from one location to another.

As used herein, a pose of a LiDAR sensor may comprise an orientation (yaw, pitch, roll) and translational position (x, y, z) of the LiDAR sensor.

As used herein, a reference LiDAR may comprise a LiDAR sensor considered to be well-calibrated. Measurements from the reference LiDAR may be used by a controller of a robot to determine a pose of a calibration LiDAR using the systems and methods of the present disclosure.

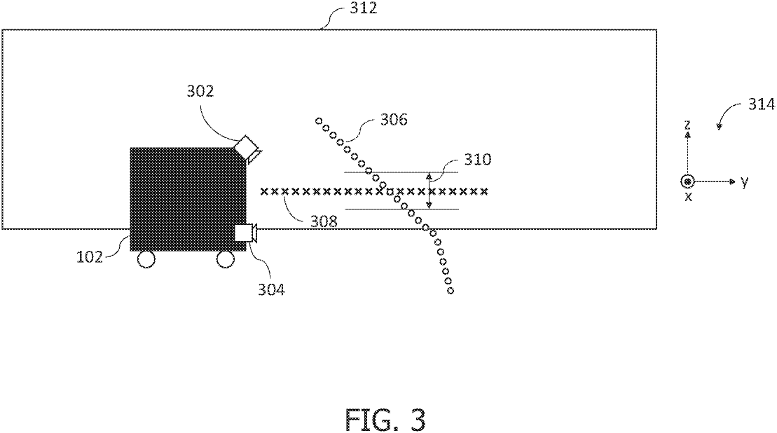

As used herein, a calibration LiDAR comprises a LiDAR sensor that may be uncalibrated or poorly calibrated, wherein the calibration of the calibration LiDAR is performed using measurements from a reference LiDAR using the systems and methods of the present disclosure. To calibrate the calibration LiDAR a pose of the calibration LiDAR may be determined, wherein a controller of a robot may adjust data from or a mounting of the calibration LiDAR based on the determined pose of the calibration LiDAR. Both the calibration LiDAR and reference LiDAR collect measurements along one or more measurement planes, wherein the measurement planes of both LiDAR sensors intersect, as illustrated below in FIG. 3.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (902.11), WiMAX (e.g., WiMAX (902.16)), PAN (e.g., PAN/902.15), cellular (e.g., 3G, LTE/LTE-A/TD-LTE/TD-LTE, GSM, etc.), IrDA families, etc. As used herein, Wi-Fi may include one or more of IEEE-Std. 902.11, variants of IEEE-Std. 902.11, standards related to IEEE-Std. 902.11 (e.g., 902.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computers (“CISC”), microprocessors, gate arrays (e.g., field programmable gate arrays (“FPGAs”)), programmable logic device (“PLDs”), reconfigurable computer fabrics (“RCFs”), array processors, secure microprocessors, processors (e.g., neuromorphic processors), and application-specific integrated circuits (“ASICs”). Such digital processors may be contained on a single unitary integrated circuit die or distributed across multiple components.

As used herein, computer program and/or software may include any sequence or human- or machine-cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) allow robots to calibrate their sensors without the need for a human operator; (ii) allow robots to calibrate their sensors in real time while operating; (iii) reduce time spent calibrating LiDAR sensors of a robot; and (iv) enhance the ability of a robot to rely on sensor data for navigation, thereby enhancing the autonomy of the robot. Other advantages are readily discernible by one having ordinary skill in the art given the contents of the present disclosure.

According to at least one non-limiting exemplary embodiment, a non-transitory, computer-readable memory comprising a plurality of instructions stored thereon is disclosed. The non-transitory, computer-readable memory comprises instructions to configure a processor to collect groups of scans comprising scan data from a calibration LiDAR and a reference LiDAR, the calibration LiDAR being a LiDAR sensor in need of calibration and the reference LiDAR being a well-calibrated LiDAR sensor; determine a pose of the calibration LiDAR based on the scan data within the groups; and adjust data or mountings of the calibration LiDAR based on the determined pose of the calibration LiDAR. The computer-readable instructions may further configure the processor to impose a selection threshold to ensure measurements used to determine an intersection between the calibration LiDAR and reference LiDAR lies within a substantially flat surface orthogonal to a measurement lane of the reference LiDAR. Additionally, the computer-readable instructions may further configure the processor to discard any determined poses not meeting a specification threshold, wherein the discarded poses may comprise improbable poses of the calibration LiDAR based on physical constraints.

According to at least one non-limiting exemplary embodiment, a method for calibrating a calibration LiDAR sensor is disclosed. The method comprises collecting a group of scans from a calibration LiDAR and an intersecting reference LiDAR. The group of scans may then be utilized to determine an error measurement based on discrepancies in localization of a flat surface orthogonal to a measurement plane of the reference LiDAR. The method further comprises minimizing the error measurement to determine a pose of the calibration LiDAR, wherein the determined pose may be used to adjust data from the calibration LiDAR or adjust a mount of the calibration LiDAR.

According to at least one non-limiting exemplary embodiment, a robotic system is disclosed. The system comprises a non-transitory, computer-readable memory and at least one processor configured to execute instructions stored on the non-transitory, computer-readable memory to cause the at least one processor to: collect a plurality of scans from a calibration LiDAR and a reference LiDAR, determine a pose of the calibration LiDAR based on errors measured between localization of a flat surface between the calibration LiDAR and reference LiDAR, and adjust data or mounting of the calibration LiDAR based on the determined pose.

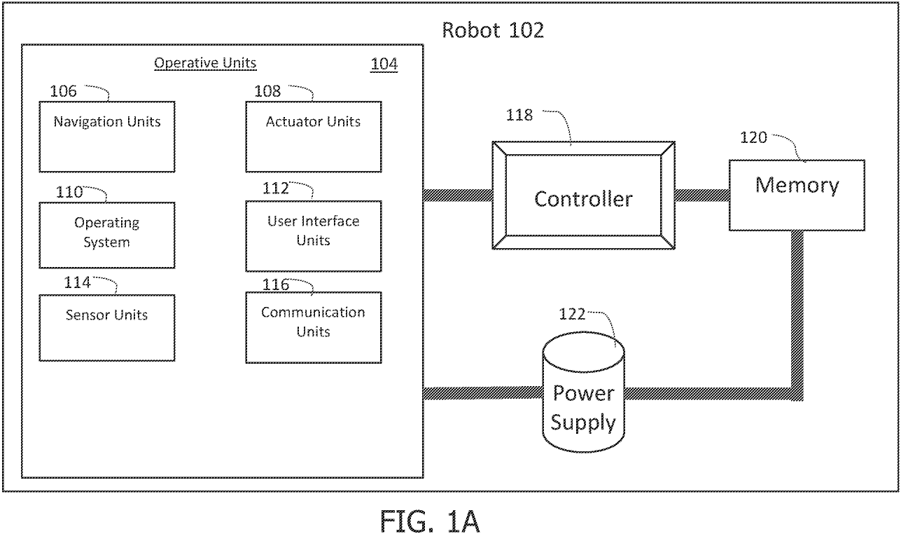

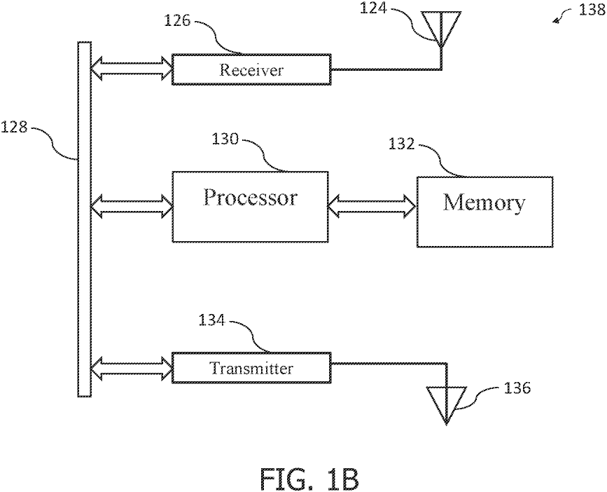

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processing devices (e.g., microprocessing devices) and other peripherals. As previously mentioned and used herein, processing device, microprocessing device, and/or digital processing device may include any type of digital processing device such as, without limitation, digital signal processing devices (“DSPs”), reduced instruction set computers (“RISC”), complex instruction set computers (“CISC”), microprocessing devices, gate arrays (e.g., field programmable gate arrays (“FPGAs”)), programmable logic device (“PLDs”), reconfigurable computer fabrics (“RCFs”), array processing devices, secure microprocessing devices and application-specific integrated circuits (“ASICs”). Peripherals may include hardware accelerators configured to perform a specific function using hardware elements such as, without limitation, encryption/description hardware, algebraic processing devices (e.g., tensor processing units, quadratic problem solvers, multipliers, etc.), data compressors, encoders, arithmetic logic units (“ALU”), and the like. Such digital processing devices may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processing device may be internal to or on board robot 102 and/or may be external to robot 102 and be communicatively coupled to controller 118 of robot 102 utilizing communication units 116 wherein the external processing device may receive data from robot 102, process the data, and transmit computer-readable instructions back to controller 118. In at least one non-limiting exemplary embodiment, the processing device may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processing devices. In some embodiments, a single controller (e.g., controller 118) may serve as the various controllers and/or processing devices described. In other embodiments different controllers and/or processing devices may be used, such as controllers and/or processing devices used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 include at least navigation units 106, actuator units 108, user interface units 112, sensor units 114, and communication units 116. Operative units 104 may also comprise other units such as specifically configured task units (not shown) that provide the various functionality of robot 102. In exemplary embodiments, operative units 104 may be instantiated in software, hardware, or both software and hardware. For example, in some cases, units of operative units 104 may comprise computer-implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magnetostrictive elements, gesticulation, and/or any way of driving an actuator known in the art. By way of illustration, such actuators may actuate the wheels for robot 102 to navigate a route; navigate around obstacles; rotate cameras and sensors. According to exemplary embodiments, actuator unit 108 may include systems that allow movement of robot 102, such as motorized propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

Actuator unit 108 may also include any system used for actuating, in some cases actuating task units to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot’s 102 position (e.g., where position may include robot’s location, displacement and/or orientation, and may sometimes be interchangeable with the term pose as used herein) relative to the initial location. Such data may be stored in data structures, such as matrices, arrays, queues, lists, stacks, bags, etc. According to exemplary embodiments, the data structure of the sensor data may be called an image.

According to exemplary embodiments, sensor units 114 may be in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, FireWire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3GPP/3GPP2), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprised of numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processing device, or robot performing a task, operation or transformation illustrated in the figures below comprises a controller executing computer-readable instructions stored on a non-transitory, computer-readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processing device 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132, which stores computer code or computer-readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

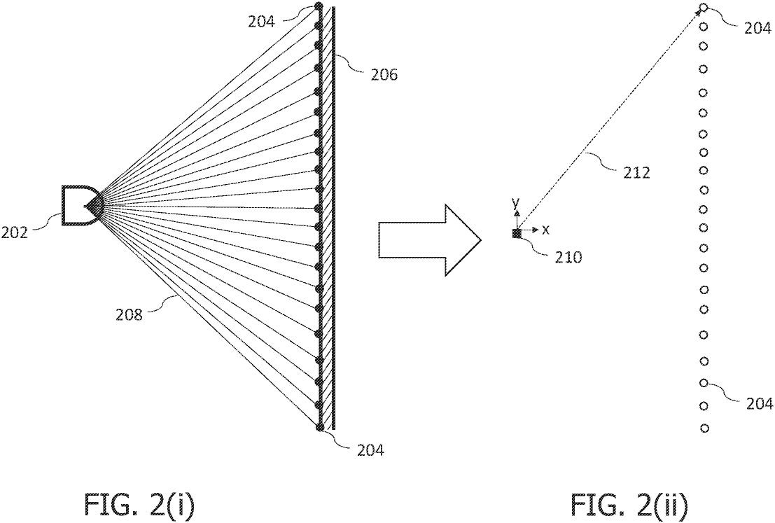

One of ordinary skill in the art would appreciate that the architecture illustrated in FIG. 1B may illustrate an external server architecture configurable to effectuate the control of a robotic apparatus from a remote location, such as server 202 illustrated next in FIG. 2. That is, the server may also include a data bus, a receiver, a transmitter, a processor, and a memory that stores specialized computer-readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer-readable instructions to perform a function may include one or more processing devices 138 thereof executing computer-readable instructions and, in some instances, the use of any hardware peripherals known within the art. Controller 118 may be illustrative of various processing devices 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processing devices 138 for performing high-level tasks (e.g., planning a route to avoid obstacles) and processing devices 138 for performing low-level tasks (e.g., producing actuator signals in accordance with the route).

FIG. 2(i-ii) illustrate a planar light detection and ranging (“LiDAR”) sensor 202 coupled to a robot 102, which collects distance measurements to a wall 206 along a measurement plane in accordance with some exemplary embodiments of the present disclosure. Planar LiDAR sensor 202, illustrated in FIG. 2(i) may be configured to collect distance measurements to the wall 206 by projecting a plurality of beams 208 of photons at discrete angles along a measurement plane and determining the distance to the wall 206 based on a time of flight (“ToF”) of the photons leaving the LiDAR sensor 202, reflecting off the wall 206, and returning back to the LiDAR sensor 202. The measurement plane of the planar LiDAR 202 comprises a plane along which the beams 208 are emitted which, for this exemplary embodiment illustrated, is the plane of the page.

Individual beams 208 of photons may localize respective points 204 of the wall 206 in a point cloud, the point cloud comprising a plurality of points 204 localized in 2D or 3D space as illustrated in FIG. 2(ii). The points 204 may be defined about a local origin 210 of the sensor 202. Distance 212 to a point 204 may comprise half the time of flight of a photon of a respective beam 208 used to measure the point 204 multiplied by the speed of light, wherein coordinate values (x, y) of each respective point 204 depends both on distance 212 and an angle at which the respective beam 208 was emitted from the sensor 202. The local origin 210 may comprise a predefined point of the sensor 202 to which all distance measurements are referenced (e.g., location of a detector within the sensor 202, focal point of a lens of sensor 202, etc.). For example, a 5-meter distance measurement to an object corresponds to 5 meters from the local origin 210 to the object.

According to at least one non-limiting exemplary embodiment, sensor 202 may be illustrative of a depth camera or other ToF sensor configurable to measure distance, wherein the sensor 202 being a planar LiDAR sensor is not intended to be limiting. Depth cameras may operate similar to planar LiDAR sensors (i.e., measure distance based on a ToF of beams 208); however, depth cameras may emit beams 208 using a single pulse or flash of electromagnetic energy, rather than sweeping a laser beam across a field of view. Depth cameras may additionally comprise a two-dimensional field of view rather than a one-dimensional, planar field of view.

According to at least one non-limiting exemplary embodiment, sensor 202 may be illustrative of a structured light LiDAR sensor configurable to sense distance and shape of an object by projecting a structured pattern onto the object and observing deformations of the pattern. For example, the size of the projected pattern may represent distance to the object and distortions in the pattern may provide information of the shape of the surface of the object. Structured light sensors may emit beams 208 along a plane as illustrated or in a predetermined pattern (e.g., a circle or series of separated parallel lines).

According to at least one non-limiting exemplary embodiment, the LiDAR sensor 202 illustrated in FIG. 2(i-ii) may represent a slice of range measurements 204 captured by a 3-dimensional (“3D”) LiDAR. 3D LiDARs operate via emitting a plurality of beams 208 along a plurality of planes, wherein each plane being separated by an angle. For example, FIG. 2(i) may be illustrative of a side view of a 3D LiDAR, wherein each beam 208 illustrated may represent a plane of measurement of the 3D LiDAR extending into and out of the plane of the page. Instead of producing a row of points 204 along a flat surface 206, a 3D LiDAR would produce a grid of points 204 on the plane of the flat surface 206. The systems and methods for calibrating LiDAR sensors discussed herein focus on calibrating two planar LiDAR sensors. One skilled in the art may appreciate that calibrating two planar LiDAR sensors is equivalent to calibrating a 3D LiDAR and a planar LiDAR by using only 1 measurement plane (i.e., one “slice”) of the 3D LiDAR.

FIG. 3 illustrates a side view of a robot 102, comprising a calibration LiDAR 302 and a reference LiDAR 304, navigating near a wall 312, according to an exemplary embodiment. The wall 312 illustrated comprises a substantially vertical wall with respect to a surface (e.g. floor) of which the robot 102 navigates. The calibration LiDAR 302 may comprise a LiDAR sensor in need of calibration based on measurements from the reference LiDAR 304, wherein the reference LiDAR 304 may be considered to be a well-calibrated LiDAR sensor. For example, the reference LiDAR 304 may be mounted onto the robot 102 using more robust mechanical means than the calibration LiDAR 302 such that the reference LiDAR 304 is less subject to movement or deviation from a factory default position. The calibration LiDAR 302 generates a plurality of measurements 306, illustrated by circles, corresponding to locations where individual beams of the calibration LiDAR 302 contact the wall 312. Similarly, the reference LiDAR 304 generates measurements 308, illustrated by crosses, along the wall 312. Both the reference LiDAR 304 and calibration LiDAR 302 illustrated comprise planar LiDAR sensors collecting distance measurements along a measurement plane. The bend in measurements 306 is intended to illustrate a three-dimensional scene, wherein measurements 306 are incident upon both wall 312 and a floor upon which the robot 102 is navigating.

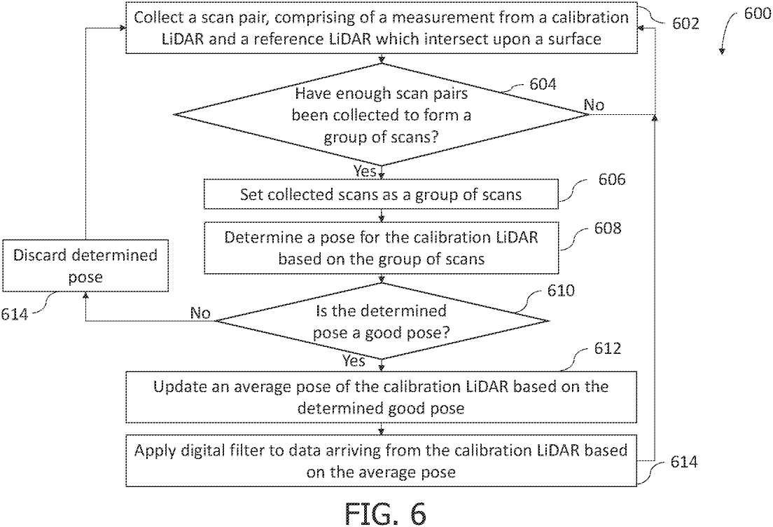

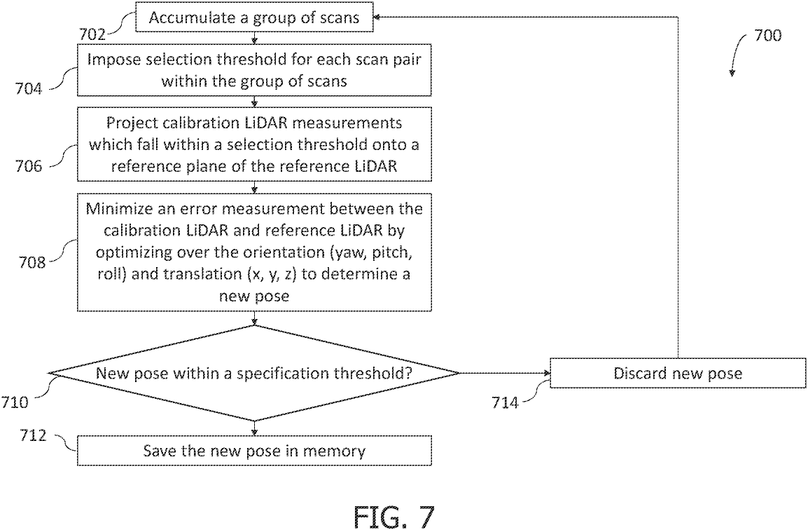

Selection threshold 310 may be imposed by a controller 118 of the robot 102 to select measurements 306 of the calibration LiDAR 302 that lie within the selection threshold 310 to be used to determine a pose of the calibration LiDAR 302 using methods 600 and 700 illustrated below in FIGS. 6 and 7, respectively. The selection threshold 310 may be determined based on a deviation from the measurement plane of the reference LiDAR 304 (e.g., ±1 centimeters, ±3 centimeters, etc.) orthogonal to the measurement plane. For example, as illustrated, the selection threshold 310 may deviate from the X-Y plane of measurement of the reference LiDAR 304, as shown by reference coordinates 314, by two (2) centimeters along the Z-axis, thereby selecting points within two (2) centimeters above and below the X-Y plane. One skilled in the art would appreciate that a measurement plane for a reference LiDAR 304 may be along any plane of reference, wherein the selection threshold 310 deviating from the X-Y plane illustrated is not intended to be limiting.

Imposing a selection threshold 310 may enable a robot 102 to ensure the measurements 306 within the selection threshold 310 comprise measurements of a substantially flat and vertical surface of the wall312. The robot 102 may collect a plurality of measurements 306 and 308 at discrete intervals in time as the robot 102 navigates near the wall 312, wherein each of the measurements 306 and 308 illustrated are measurements taken at a single instance in time (e.g., a single sweep of a laser beam across the fields of view of the two LiDARs 302, 304).

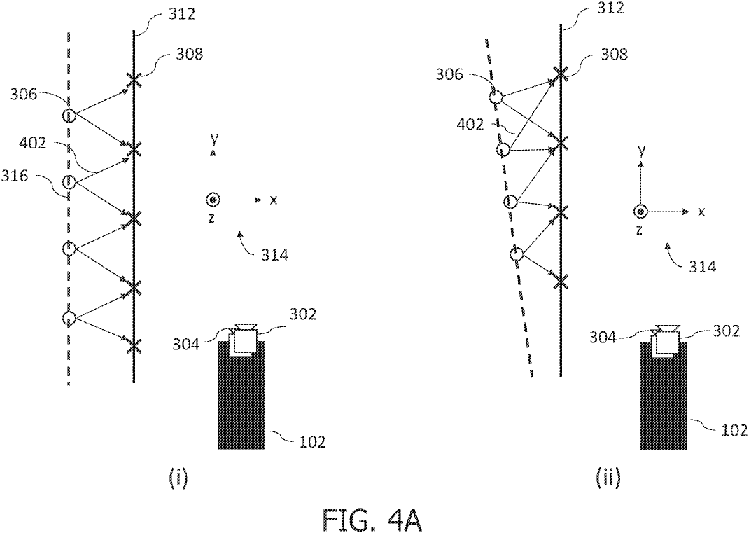

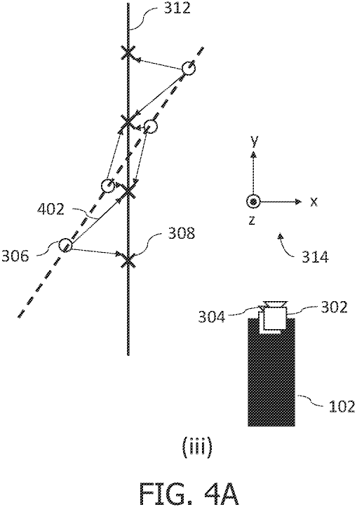

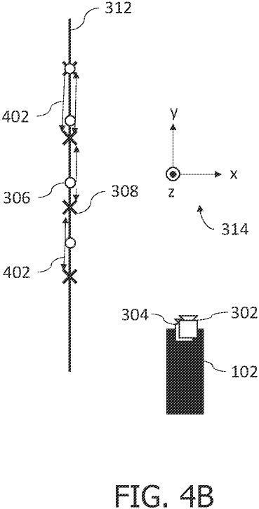

According to at least one non-limiting exemplary embodiment, a reference LiDAR 304 may comprise a 3D LiDAR, wherein a selection threshold 310 may be determined based on a deviation from one plane of reference of the plurality of measurement planes of the 3D LiDAR. According to at least one non-limiting exemplary embodiment, a calibration LiDAR 302 may comprise a 3D LiDAR, wherein a selection threshold 310 may still be determined based on a deviation from a plane of reference of a reference LiDAR 304, however, a plurality of additional measurements 306 may be included within the selection threshold 310. These additional measurements may further define the surface of the flat wall object 312, which in turn further defines the location and orientation of line 316 shown next in FIG. 4A(i-iii). Further defining the location and orientation of line 316, representative of where the 3D LiDAR localizes the object 312, may yield a more accurate transformation and error measurements 402. It may be appreciated that, if both the 3D LiDAR and reference LiDAR 304 are well calibrated, the reference LiDAR 304 should intersect with the measurements of the 3D LiDAR at known locations based on the distance between the robot 102 and the object 312, the distance to the object being determined using the reference LiDAR 304. Stated differently, the controller 118 may calculate which circle 306 will intersect with which cross 308 based on the distance to the object 312 and the orientation of the two LiDAR sensors 302, 304, wherein any discrepancy may yield pose information about the calibration LiDAR 302 as will be discussed below.

FIG. 4A(i-iii) illustrate a plurality of errors 402 measured due to incorrect positioning of a calibration LiDAR 302 with respect to its orientation (yaw, pitch, roll) and translation (x, y, z) projected onto a plane of reference of a reference LiDAR 304, according to exemplary embodiments. The position of measurements 306 and 308 are illustrative of where the robot 102 localizes a wall 312 based on measurement data from a calibration LiDAR 302 and a reference LiDAR 304, respectively. For simplicity of illustration, both the wall and the direction of travel of robot 102 are aligned with the Y-axis, as shown by reference coordinates 314, which are the same coordinates shown in FIG. 3. The dashed line 316 is illustrated to clearly indicate where the calibration LiDAR 302 detects the wall 312, however, this localization is in error and does not represent a real object, such as a wall. The measurements 306 and 308 are projected on a measurement plane of the reference LiDAR 304. Measurements 308 are measured by a reference LiDAR 304 considered to be well calibrated and measurements 306 are measured from a calibration LiDAR 302 which may not be well calibrated. Accordingly, localization of the wall 312 as illustrated is based on localization of the wall 312 by the reference LiDAR 304 using measurements 308. For illustration of the method, measurements 306 are shown as not being in alignment with the localization of wall 312. This may cause the controller 118 to perceive two objects nearby the robot 102, the wall 312 (represented by measurements 308) and a second “wall” shown by the dashed line 316, which, in reality, is the same wall 312 but localized incorrectly.

First, in FIG. 4A(i), measurement points 306 localizes the wall 312 at the dashed line 316, beyond where measurement points 308 localize the wall 312 which may correspond to the calibration LiDAR 302 being miss-positioned on the robot 102 along an X-axis, defined by reference coordinates 314 comprising the same reference coordinates illustrated in FIG. 3 from a different perspective. The four measurement points 306 illustrated may have been determined to be measurement points 306, which lie within a selection threshold 310, illustrated above in FIG. 3. Errors 402 may be calculated between each measurement 306 and their closest two neighboring measurements 308. Errors 402 may be utilized in calculating an error measurement 406 using a L₁, L₂, root mean square (“RMS”), or other error measurement calculation based on a difference of X and Y coordinates of a measurement 306 and its closest neighboring measurements 308, as illustrated below in Equation 1.

According to at least one non-limiting exemplary embodiment, the reference LiDAR 304 may comprise a measurement plane, which is not aligned with the X-Y axis. In this embodiment, the measurements 306 within the selection threshold 310 may be chosen and projected onto the plane of the reference LiDAR 304, wherein errors 402 are determined within the plane of the reference LiDAR 304.

Next, FIG. 4A(ii) illustrates another exemplary embodiment illustrating a plurality of incorrect measurements 306, determined to lie within the selection threshold 310. The spacing between measurements 306 and 308 (i.e., the discrepancy between localization of the wall for the two sensors 302, 304) is exaggerated for clarity. The localization of the wall based on measurements 306 (i.e., shown by 316) may be skewed with respect to the wall 312 axis, which follows a Y-axis as illustrated by the reference coordinates 314. This may be due to, for example, incorrect orientation and/or position of the calibration LiDAR 302 with respect to yaw, pitch, roll, x-position, y-position, z-position, or a combination thereof. Accordingly, errors 402 may be calculated between each measurement 306 and their closest two neighboring measurements 308 as illustrated.

Lastly, FIG. 4A(iii) illustrates another exemplary embodiment of localization of the wall (316) based on measurements 306, determined to lie within a selection threshold 310, skewed with respect to the axis of wall 312, which follows the Y-axis as illustrated by the reference coordinates 314. The skew of the measurements 306 may be due to incorrect orientation of the calibration LiDAR 302 with respect to yaw, pitch, roll, or a combination thereof. Accordingly, errors 402 may be calculated between each measurement 306 and its closest two neighboring measurements 308 as illustrated.

According to at least one non-limiting exemplary embodiment, errors 402 may be calculated from each measurement point 306 to its closest three, or more, neighboring measurements 308.

One skilled in the art would appreciate that the measurements 306 illustrated in FIG. 4A may be caused by any orientation (yaw, pitch, roll) and/or translation (x, y, z) error of the calibration LiDAR 302, as there may be a plurality of degenerate states for a pose of the calibration LiDAR 302 which cause the measurements 306 to localize a wall 312 at 316 as illustrated. Accordingly, the systems and methods of the present disclosure illustrated below may enable a robot 102 to determine a pose of the calibration LiDAR 302 despite a plurality of degenerate poses of the calibration LiDAR 302 which may cause the observed measurements 306.

According to at least one non-limiting exemplary embodiment, in order to calibrate the calibration LiDAR 302 with respect to the reference LiDAR 304, the vertical surface of the object 312 within the selection threshold 310 must be planar. That is, if the calibration LiDAR 302 and/or reference LiDAR 304 detect an uneven, non-vertical surface (e.g., a shelf) the surface cannot be used to calibrate the calibration LiDAR 302 using the systems and methods of this disclosure. Stated differently, if line 416 is not straight (e.g., due to a protrusion or indent in the object 312) the calibration must be skipped or delayed until the robot 102 encounters a surface which is flat and vertical within the selection threshold 310.

FIG. 4B illustrates a top view of measurements 306 and 308 of a wall 312 from a calibration LiDAR 302 and a reference LiDAR 304, respectively, wherein a pose of a calibration LiDAR 302 has been determined and accounted for by a controller 118 of a robot 102, according to an exemplary embodiment. As illustrated, the measurements 306 and 308 both lie parallel to the Y-axis of the reference coordinates 314 at the same X-coordinate (i.e., along the axis of the wall 312), but are at different Y-coordinates. One skilled in the art would appreciate that the measurements 306 and 308 along the wall 312 may not all be located at the same Y coordinate, but errors 402 would be minimized if the location of the wall 312 is determined to be at the same X-axis location based on measurements from both the calibration LiDAR 302 and the reference LiDAR 304.

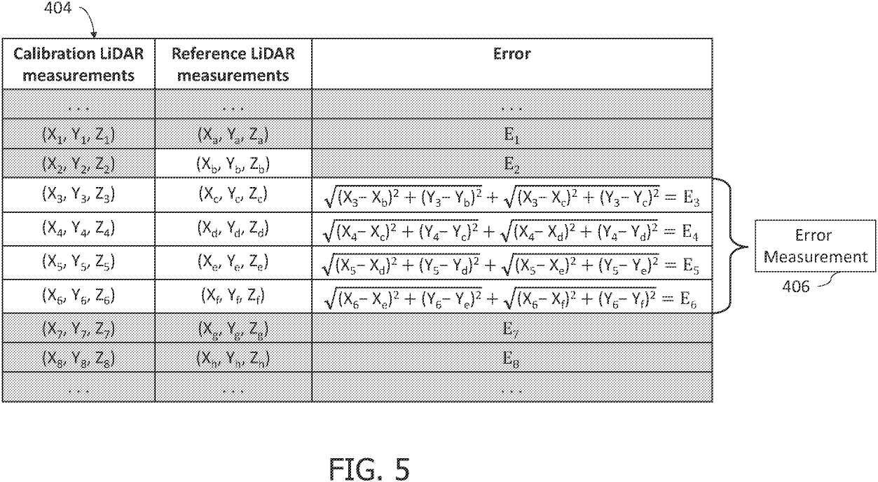

As used herein, an aggregate error measurement 406, reflected in FIG. 5, may comprise an L₁ error measurement 406 calculation using the following Equation 1:

$$\left[E r r o r M e a s u r e m e n t\right] = {\sum }_{i = 1}^{I} \left|{E}_{i}\right|$$

The value of [Eᵢ may correspond to the magnitudes of the errors 402 and index I may correspond to the total number of errors 402 measured between each measurement 306 and its neighboring two, or in some embodiments three or more, closest measurements 308. According to Equation 1, an error measurement 406 comprises a sum of the magnitudes of all of the errors 402 detected between measurements 306 and 308 taken within a selection threshold 310, illustrated in FIG. 3 above. One skilled in the art would appreciate that a minimum value for an error measurement 406 may be calculated when the calibration LiDAR 302 and reference LiDAR 304 localize the wall 312 at the same location along the axis of the wall (i.e., the Y-axis), as illustrated in FIG. 4B. The minimum value may be nonzero.

According to some non-limiting exemplary embodiments, other error measurement 406 calculations may be utilized such as, for example, L₂, RMS, and the like, wherein use of L₁ error is intended to be illustrative and non-limiting.

FIG. 5 illustrates a data table 404 comprising a plurality of calibration LiDAR measurements 306 and reference LiDAR measurements 308 stored in memory 120 of a robot 102, according to an exemplary embodiment. Calibration LiDAR and reference LiDAR measurements 306 and 308 may comprise localization parameters of a wall 312 nearby the robot 102 using Cartesian coordinates (x, y, z). The data entries of table 504 may represent a single scan from each LiDAR 302, 304 captured at approximately the same time. Each entry in the first or second columns represent a point 204 and its location in the environment. In some embodiments, the entries of the data table may comprise of a plurality of sequential scans aggregated together.

Upon imposing a selection threshold 310, a plurality of data entries in the table 404 may be removed during calculation of an error measurement 406, as illustrated by some entries being shaded in grey. Four (4) calibration LiDAR measurements 306, for example, may have been determined by a controller 118 of the robot 102 to lie within the selection threshold 310 range; however in other embodiments more or fewer measurements 306 may be selected (e.g., based on a resolution of the calibration LiDAR and size of the selection threshold 310). Accordingly, the four (4) measurements 306 and five (5) neighboring reference LiDAR measurements 308 are kept within the data table 404. Data table 404 further comprises an error column containing values for errors E¡ between a measurement 306 and its neighboring two measurements 308, wherein each square root calculation may correspond to an error 402 illustrated above in FIGS. 4A-B. Each error Eᵢ may be calculated based on a Euclidian distance calculation between each measurement 306 and its closest two neighboring measurements 308 projected onto a measurement plane of the reference LiDAR 304, wherein the measurement plane of the reference LiDAR 304 in this embodiment is the X-Y plane. Errors three through six (E₃-E₆), comprising errors 402 measured between measurements 306 which fall within the selection threshold 310 and their closest two neighboring measurements 308, may be used to determine the error measurement 406 based on Equation 1 above.

By way of illustration, a different configuration of a calibration LiDAR 302 and a reference LiDAR 304 is considered, wherein the two sensors comprise measurement planes that intersect on a floor. The reference LiDAR 304 may measure along the Y-Z plane for simplicity of explanation while the calibration LiDAR 302 may measure along a slanted plane. Accordingly, the error measurement 406 may comprise a Euclidean distance calculation using Y and Z components of measurements 306, 308. The error measurements 406 may be based on the two sensors localizing the floor at a different height, similar to the two sensors in the illustrated embodiment localizing the wall 312 at different locations along a different axis.

According to at least one non-limiting exemplary embodiment, only errors along the X-axis may be considered in the calculation of error measurement 406. For example, with reference to FIG. 4A(iii), minimizing errors 402 along the X axis may include rotation of the points 306 to match substantially with points 308, wherein there may always exist some nonzero error along the Y axis (as shown in FIG. 4B). The rotations are performed by rotating the origin 210 of the calibration LiDAR 302 which, in turn, causes the points 306 measured by the calibration LiDAR 302 to rotate about the origin 210. Similarly for translations, the origin 210 is translated which, in turn, translates the points 306. Stated more generally, in some embodiments, error measurements 406 may be calculated using only components of the errors 402 which are normal to the surface upon which the two LiDARs 302, 304 intersect. For example, if the two LiDARs 302, 304 intersect on a floor in front of the robot 102, the Z component only may be utilized to calculate error measurements 406.

One skilled in the art would appreciate table 404 may be illustrative of a self-referential data table, wherein rows and/or columns may be added and/or removed as a robot 102 collects more scans at different discrete instances in time and/or as a controller 118 executes computer-readable instructions in a memory 120 of the robot 102. Additionally, one skilled in the art would appreciate the X-Y plane on which the measurements 306 and 308 are projected to calculate errors 402 may be oriented along any measurement plane of a reference LiDAR 304.

FIG. 6 illustrates a method 600 for a controller 118 of a robot 102 to determine and/or update an average pose of a calibration LiDAR 302 based on a plurality of measurements from the calibration LiDAR 302 and a reference LiDAR 304, according to an exemplary embodiment. The average pose may be utilized by the controller 118 to calibrate the calibration LiDAR 302 by adjusting measurements from the calibration LiDAR 302 based on the average pose.

Block 602 illustrates the controller 118 collecting a scan comprising measurements from the calibration LiDAR 302 and the reference LiDAR 304. A scan may comprise a measurement from the calibration LiDAR 302 and reference LiDAR 304 across their respective fields of view of a surface, such as a wall 312 illustrated above in FIG. 3.

Block 604 illustrates the controller 118 determining if enough scans have been collected to form a group of scans. A group threshold may be imposed to determine the number of scans which may comprise a group of scans. The group threshold may comprise any number of scans (e.g., 2, 10, 15, 100, etc. scans per group) that may correspond to a threshold for enough scans.

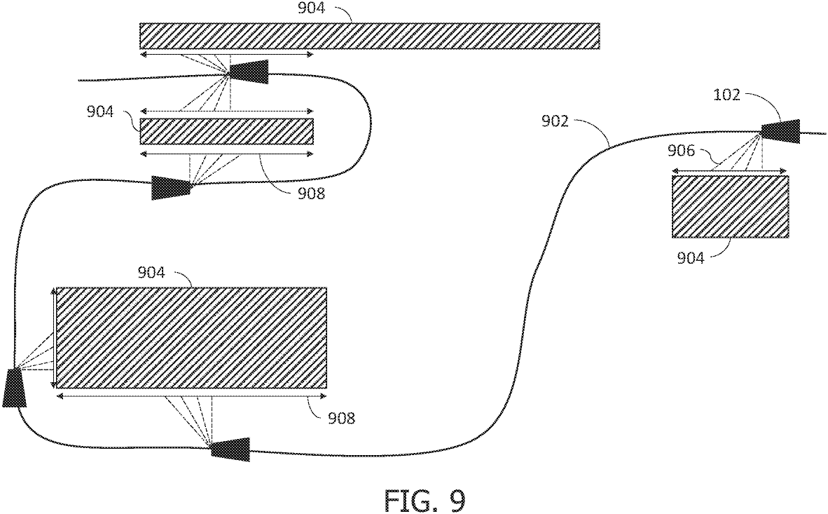

According to at least one non-limiting exemplary embodiment, the group threshold may comprise a minimum number and a maximum number of scans within a group of scans to account for a robot 102 moving beyond a surface and no longer collecting scans of the surface. Accordingly, if the number of scans of the surface exceeds the maximum threshold, a first group of scans may be formed comprising the maximum number of scans and one or more additional groups of scans may be formed from the remaining scans of the surface, provided those remaining groups of scans include at least the minimum number of scans. If the number of scans of the surface does not exceed the minimum, the controller 118 may discard the remaining scans and start collecting more scans upon navigating near a new surface, as illustrated below in FIG. 9. The minimum number of scans may be selected to provide the controller 118 with sufficient data to determine accurate error measurements 406, wherein use of a single scan may be subject to noise or other imperfections (e.g., robot 102 may experience a bump in the floor or other perturbation during a single scan) and/or may yield a degenerate incorrect solution. The maximum number of scans may be selected based on (i) hardware capabilities of the controller 118 (e.g., processing speed), and (ii) to ensure the optimization step, shown in block 608 below, yields reliable results (e.g., detects a global minimum rather than a local minimum).

Upon the controller 118 determining whether enough scans may form a group of scans, the controller 118 moves to block 606.

Upon the controller 118 determining not enough scans have been collected to form a group of scans, the controller 118 moves back to block 602 to collect more scans.

Block 606 illustrates the controller setting the collected scans as a group of scans. The group of scans may comprise an array, matrix, or similar data structure of measurement data from the calibration and reference LiDARs stored in memory 120 of the robot 102. The scan data stored in memory 120 may comprise measurements from the calibration LiDAR that fall within a selection threshold 310 of a measurement plane of the reference LiDAR.

Block 608 illustrates the controller 118 determining a pose for the group of scans. The pose may be determined based on a minimization of an error measurement 406 calculated above using Equation 1. The method for determining a pose for the group of scans as well as determining if the pose comprises a good pose is further illustrated in method 700 of FIG. 7 below.

Block 610 illustrates the controller 118 determining if the determined pose is a good pose. The determination of a good pose is based on a specification threshold, illustrated below in FIG. 6.

Upon the controller 118 determining the pose comprises a good pose, the controller 118 moves to block 612.

Upon the controller 118 determining the pose does not comprise a good pose, the controller 118 moves to block 614 to discard the determined pose and subsequently return to block 602 to begin collecting a new group of scans.

Block 612 illustrates the controller 118 updating the average pose based on the determined pose, determined to be a good pose of the calibration LiDAR 302 in block 610. The average pose may comprise an average of a plurality of good poses calculated based on prior groups of scans collected, wherein the average pose is updated upon the controller 118 determining a new good pose in block 610. One skilled in the art would appreciate that a good pose corresponds to a desirable pose.

According to at least one non-limiting exemplary embodiment, upon initialization of a robot 102, an average pose may comprise NULL, zero, or default (i.e., factory specified) values for its orientation (yaw, pitch, roll) or translation (x, y, z) position, wherein a first pose determined from a first group of scans may be set as the average pose.

FIG. 7 illustrates a method 700 for a controller 118 of a robot 102 to determine a good pose based on a group of scans, according to an exemplary embodiment. The good pose determined based on the group of scans may be utilized by the controller 118 to update an average pose of the calibration LiDAR 302. Both calibration LiDAR 302 and reference LiDAR 304 may comprise planar LiDARs measuring distance measurements along a plane.

Block 702 illustrates the controller 118 accumulating a group of scans. The group of scans may comprise a plurality of scans from the calibration LiDAR 302 and reference LiDAR 304 of a surface, such as wall 312 illustrated in FIG. 3. The number of scans within a group may be determined by a group threshold set by the controller 118 or specified by an operator of the robot 102.

Block 704 illustrates the controller 118 imposing a selection threshold 310 for each scan within the group of scans. The selection threshold 310, illustrated in FIG. 3, may comprise a small deviation (e.g., ±1 centimeters, ±3 centimeters, etc.) along a measurement plane of the reference LiDAR 304. The selection threshold 310 may be imposed by the controller 118 to ensure measurements 306 of the calibration LiDAR 302 within the selection threshold 310 are measurements of a substantially flat surface (i.e., no bumps or features of the surface, which may cause localization of the surface to vary).

Block 706 illustrates the controller 118 projecting the remaining calibration LiDAR measurements 306 onto the measurement plane of the reference LiDAR 304. According to at least one non-limiting exemplary embodiment, a calibration LiDAR 302 may comprise a 3D LiDAR wherein a controller 118 may project measurements 306 of the 3D calibration LiDAR 302 onto a measurement plane of a planar reference LiDAR 304. According to at least one non-limiting exemplary embodiment, a reference LiDAR 304 may comprise a 3D LiDAR wherein a controller 118 may project measurements 306 of the calibration LiDAR 302 onto one or more measurement planes of the 3D reference LiDAR 304.

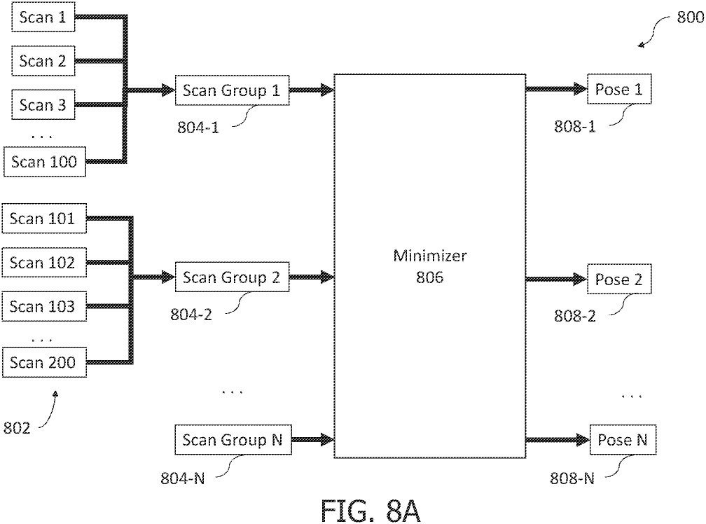

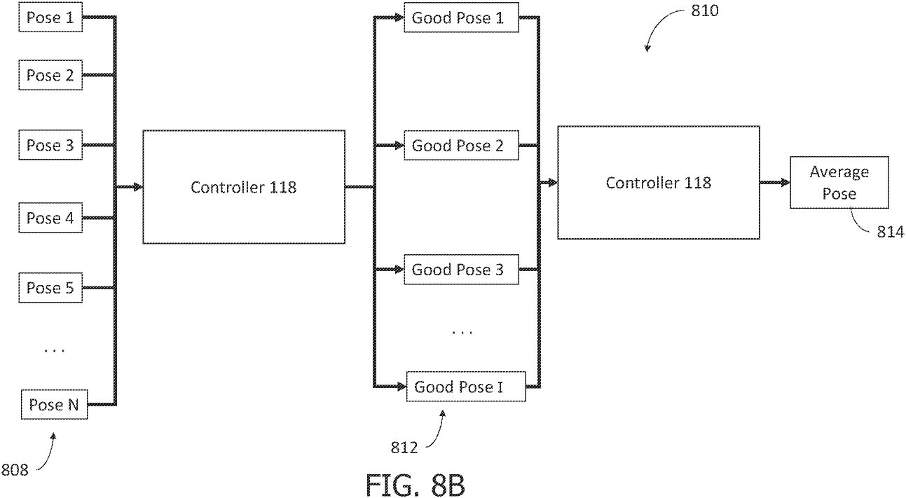

Block 708 illustrates the controller 118 utilizing a minimizer 806, illustrated below in FIG. 8, to minimize an error measurement 406, determined by Equation 1 above, between measurements 306 and their neighboring measurements 308 from the calibration LiDAR 302 and reference LiDAR 304, respectively, by optimizing over the orientation (yaw, pitch, roll) and translation (x, y, z) to determine a new pose. The minimizer 806 may be configured to determine a pose of the calibration LiDAR 302 which minimizes the error measurement 406 determined by Equation 1 above.

Block 710 illustrates the controller 118 determining if the new pose is within a specification threshold. A pose within the specification threshold may be determined to be a good pose to be used to update an average pose of the calibration LiDAR 302. The specification threshold may comprise maximum error for any orientation (yaw, pitch, roll) and translation (x, y, z) value. Imposing the specification threshold may enable the controller 118 to determine if the new pose calculated by the minimizer 806 is an outlier pose, wherein an outlier pose may comprise a pose of the calibration LiDAR 302 which may not be plausible. For example, a specification threshold may impose threshold yaw, pitch, and roll values of a new pose that must not exceed 20° of a calibrated or default pose of the calibration LiDAR, because it may not be possible for the calibration LiDAR 302 to exceed a 20° error in its orientation coordinates (yaw, pitch, roll) due to physical constraints such as a mounting (e.g., screws, bolts, etc.) which attach the calibration LiDAR 302 to the robot 102. The minimizer 806 may determine that a minimum of the error measurement 406 lies outside a plausible range of orientation (yaw, pitch, roll) and translation (x, y, z) values due to physical constraints of the calibration LiDAR 302 and/or how the calibration LiDAR 302 is mounted onto the robot 102. In other words, the specification threshold may set bounds for the yaw, pitch, roll, x-position, y-position, and z-position of the calibration LiDAR for the minimizer 806 based on reasonable physical constraints.

One skilled in the art would appreciate a robot 102 may navigate nearby walls with uneven surfaces or slanted surfaces, which may cause a minimizer 806 to output a pose of a calibration LiDAR 302 that exceeds a specification threshold. Advantageously, the use of a specification threshold may enhance the accuracy of an average pose of the calibration LiDAR 304 by discarding calculated poses, which may be outlier poses, for example, due to uneven or slanted surfaces upon which groups of scans are measured.

Upon the controller 118 determining the new pose is within the specification threshold, the controller 118 moves to block 712.

Upon the controller 118 determining the new pose is not within the specification threshold, the controller 118 moves to block 714 to discard the new pose.

Block 712 illustrates the controller 118 saving the new pose in memory 120. The new pose may be utilized to update the average pose based on an average between the new pose and a plurality of other poses calculated from prior groups of scans.

FIG. 8A is a functional block diagram of a system 800 configured to determine a plurality of poses 808 of a calibration LiDAR 302 based on scans 802 collected by the calibration LiDAR 302 and a reference LiDAR 304, according to an exemplary embodiment.

Scans 802 may comprise calibration LiDAR 302 measurements 306 within a selection threshold 310, determined by a deviation from a measurement plane of the reference LiDAR 304. Each scan 802 may be taken at discrete intervals in time and may be accumulated into scan groups 804. Scan groups 804 comprise a plurality of scans 802 to be utilized by a minimizer 806 to determine a pose of the calibration LiDAR 302 based on the scan groups 804. Scan groups 804 may comprise, for example, one hundred (100) scans 802 captured sequentially along a same surface. According to at least one non-limiting exemplary embodiment, a scan groups 804 may comprise more or fewer than one hundred (100) scans 802. According to at least one non-limiting exemplary embodiment, each scan group 804 may comprise the same number or a different number of scans 802 as other scan groups 804.

Scans 802 must detect a flat surface within the selection threshold 310. If the surface is not flat (e.g., includes protrusions/indents) then the scan must be discarded. For example, the reference LiDAR 304 may sense the base of a shelf whereas the calibration LiDAR 304 may sense an indent of the shelf itself, wherein aligning these scans yields no useful pose information.

Minimizer 806 is configured to minimize an error measurement 406, determined by Equation 1 above, of each scan group 804 utilizing specialized algorithms stored in memory 120 of a robot 102. These algorithms may include, for example, Broyden-Fletcher-Goldfarb-Shanno (BFGS) algorithms, low memory BFGS algorithms, constrained optimization by linear approximation (COBYLA) algorithms, sequential quadratic programming (SQP), and/or other similar optimization algorithms configured to minimize the error measurement 406 by determining a pose of the calibration LiDAR 302. Minimizer 806 may determine a pose 808 based on the scans 802 within a scan group 804, wherein the pose 808 may be the pose of the calibration LiDAR 302 such that the error measurement 406 is at a minimum. Minimizer 806 may be a separate operative unit of the robot 102 or may be illustrative of the controller 118 executing computer-readable instructions in memory 120. Over time, the minimizer 806 may output a plurality of poses 808 as the robot 102 collects additional scans 802. The plurality of poses 808 may be used by the controller 118 to determine an average pose 814 using a system 810 illustrated below in FIG. 8B.

FIG. 8B illustrates a system 810 configured to determine an average pose 814 based on a plurality of poses 808 determined by a system 800 illustrated above in FIG. 8A, according to an exemplary embodiment. The average pose 814 may be a best pose estimate of the calibration LiDAR 302 used to enhance the ability of the controller 118 to adjust data arriving from the calibration LiDAR 302 to account for the determined average pose such that data arriving from the calibration LiDAR 302 may be substantially similar to data arriving from a perfectly calibrated calibration LiDAR 302.

A controller 118 of a robot 102 may receive a plurality of poses 808 from a minimizer 806, illustrated above in FIG. 8A, and determine good poses 812 from the plurality of poses 808. A good pose 812 may be a pose 808 that does not exceed a specification threshold, illustrated above in FIG. 7. The specification threshold may be threshold value for each orientation (yaw, pitch, roll) and translation (x, y, z) coordinate value, wherein a pose 808 comprising a coordinate value exceeding the specification threshold may be discarded due to the pose being outside of physical constraints of the calibration LiDAR 302 (e.g., roll cannot exceed 10° of a perfectly calibrated calibration LiDAR 302 pose due to mounting of the calibration LiDAR 302). The controller 118 may receive “N” poses 808 from the minimizer 806 and output “I” good poses 812 meeting the specification threshold, wherein indices “N” and “I” correspond to integer numbers of poses 808 received and good poses 812 outputted, respectively, by the controller 118 and “N” is larger than or equal to “I.” The plurality of good poses 812 may be averaged by the controller 118 to determine an average pose 814. Each coordinate value (e.g., yaw, pitch roll, x, y, and z) of the average pose 814 may comprise an average of the respective coordinate value of all good poses 812 determined by the controller 118. The average pose 814 may be utilized by the controller 118 to adjust sensor data from the calibration LiDAR based on the average pose 814 of the calibration LiDAR 302.

According to at least one non-limiting exemplary embodiment, a calibration LiDAR 302 may be fitted with servomotors of actuator units 108 configured to adjust the orientation and position of the calibration LiDAR 302 based on an average pose 814. A controller 118 may activate the servomotors to reposition the calibration LiDAR 302 such that the calibration LiDAR 302 is in its calibrated orientation and position. Upon the robot 102 navigating nearby another surface upon which the calibration LiDAR 302 and reference LiDAR 304 intersect, the controller 118 may expect the error measurements 406 to decrease. If the errors increase, the controller 118 may undo the adjustment of the calibration LiDAR 302 in some embodiments. The controller 118 may collect additional scans of the surface to update the average pose for further adjustments.

According to another non-limiting exemplary embodiment, data from a calibration LiDAR 302 may be modified based on a determined average pose 814 using a digital filter. For example, an average pose may include the calibration LiDAR 302 being at a pitch angle differing from a calibrated value, wherein data from the calibration LiDAR 302 is modified to account for the pitch of the average pose by the digital filter. The digital filter may comprise a spatial transformation of data (i.e., localized points) received by the calibration LiDAR 302.

FIG. 9 illustrates a robot 102 navigating along a route 902 while collecting a plurality of scans, illustrated by sensor vision lines 906, according to an exemplary embodiment. The robot 102 may determine the route 902 based on an assigned task to perform assigned by an operator of the robot 102. As the robot 102 navigates the route 902 it comes within close proximity of a plurality of environmental objects 904. Environmental objects 904 may comprise, for example, shelves within a store or other static objects within an environment. Sensor vision lines 906 may be illustrative of the robot 102 collecting distance measurements from a calibration LiDAR 302 and a reference LiDAR 304. The robot 102 may collect a plurality of scans as it navigates nearby objects 904, wherein the plurality of scans are taken along surfaces 908 of the objects 904.

As illustrated, scans are taken on both sides of the robot 102 based on the location of the objects 904 relative to the robot 102 as the robot 102 navigates along route 902. Additionally, some scans may be taken on both sides of the robot 102 simultaneously, or alternatively from one side at any given time. Collecting scan data from both sides of the robot 102 may further enhance the ability of the controller 118 to determine a pose of the calibration LiDAR 302 as the controller 118 is provided with additional surfaces 908 to collect scan data from. A robot 102 may determine a scan group 804 based on the number of scans collected as it navigates near an object 904, wherein each scan group 804 may comprise a variable number of scans depending on the length of a surface 908 from which the robot 102 collects the scan data.

One skilled in the art would appreciate that the systems and methods of the present disclosure for determining a pose of a calibration LiDAR 302 may be utilized as the robot 102 performs other tasks and navigates past objects 904. A robot 102 may determine an average pose of a calibration LiDAR 302 by navigating nearby objects 904 for the purpose of calibrating the calibration LiDAR 302. Additionally, a robot 102 collecting scan data from a plurality of surfaces 908 of objects 904 on both sides of the robot 102 may further enhance the accuracy of a determined average pose of a calibration LiDAR 302.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being redefined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term ‘includes” should be interpreted as “includes but is not limited to;” the term “example” or the abbreviation “e.g.” is used to provide exemplary instances of the item in discussion, not an exhaustive or limiting list thereof, and should be interpreted as “example, but without limitation;” the term “illustration” is used to provide illustrative instances of the item in discussion, not an exhaustive or limiting list thereof, and should be interpreted as “illustration, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A non-transitory computer readable storage medium comprising a plurality of computer readable instructions stored thereon, that when executed by a controller configure the controller to:
collect a group of scans using a calibration LiDAR and a reference LiDAR, the group of scans comprising a plurality of scans of a surface from both the calibration LiDAR and the reference LiDAR;
determine a pose of the calibration LiDAR based on the group of scans; and
adjust the calibration LiDAR based on an average pose, the average pose determined based on an average of a plurality of determined poses of the calibration LiDAR,
wherein at least one measurement plane of the calibration LiDAR and reference LiDAR intersect upon the surface.

2. The non-transitory computer readable storage medium of claim 1, wherein the controller is further configured to execute the computer readable instructions to:
impose a selection threshold orthogonal to a measurement plane of the reference LiDAR; and
impose a specification threshold to determine if a determined pose comprises a desirable pose, the desirable pose is based on a specification threshold.

3. The non-transitory computer readable storage medium of claim 2, wherein the controller is further configured to execute the computer readable instructions to,
discard a scan from the group of scans if the surface is non-flat within the selection threshold.

4. The non-transitory computer readable storage medium of claim 1, wherein the controller is further configured to execute the computer readable instructions to,
determine the pose of the calibration LiDAR based on minimizing an error measurement calculation, the minimizing is performed via at least one of rotating and translating scans of the group of scans about the origin of the calibration LiDAR.

5. The non-transitory computer readable storage medium of claim 1, wherein the controller is further configured to execute the computer readable instructions to,
collect a new group of scans upon the robot detecting a different surface using the calibration LiDAR and reference LiDAR; and
update the average pose based upon the new group of scans of the different surface.

6. A robotic system for traveling along a route, comprising:
a non-transitory computer readable memory comprising computer readable instructions; and
at least one controller configured to execute the instructions to:
collect a group of scans using a calibration LiDAR and a reference LiDAR positioned on the robotic system, the group of scans comprising a plurality of scans of a surface from both the calibration LiDAR and the reference LiDAR;
determine a pose of the calibration LiDAR based on the group of scans; and
adjust the calibration LiDAR based on an average pose, the average pose determined based on an average of a plurality of determined poses of the calibration LiDAR,
wherein at least one measurement plane of the calibration LiDAR and reference LiDAR intersect upon the surface.

7. The robotic system of claim 6, wherein the at least one controller is further configured to execute the computer readable instructions to:
impose a selection threshold orthogonal to a measurement plane of the reference LiDAR; and
impose a specification threshold to determine if a determined pose comprises a desirable pose, the desirable pose is based on a specification threshold.

8. The non-transitory computer readable storage medium of claim 7, wherein the at least one controller is further configured to execute the computer readable instructions to:
discard a scan from the group of scans if the surface is non-flat within the selection threshold.

9. The non-transitory computer readable storage medium of claim 6, wherein the at least one controller is further configured to execute the computer readable instructions to:
determine the pose of the calibration LiDAR based on minimizing an error measurement calculation, the minimizing is performed via at least one of rotating and translating scans of the group of scans about the origin of the calibration LiDAR.

10. The non-transitory computer readable storage medium of claim 6, wherein the at least one controller is further configured to execute the computer readable instructions to:
collect a new group of scans upon the robot detecting a different surface using the calibration LiDAR and the reference LiDAR; and
update the average pose based upon the new group of scans of the different surface.

11. A method for a robotic device traveling along a route, comprising:
collecting a group of scans using a calibration LiDAR and a reference LiDAR, the group of scans comprising a plurality of scans of a surface from both the calibration LiDAR and reference LiDAR;
determining a pose of the calibration LiDAR based on the group of scans; and
adjusting the calibration LiDAR based on an average pose, the average pose determined based on an average of a plurality of determined poses of the calibration LiDAR,
wherein at least one measurement plane of the calibration LiDAR and reference LiDAR intersect upon the surface.

12. The method of claim 11, further comprising:
imposing a selection threshold orthogonal to a measurement plane of the reference LiDAR; and
imposing a specification threshold to determine if a determined pose comprises a desirable pose, the desirable pose is based on a specification threshold.

13. The method of claim 12, further comprising:
discarding a scan from the group of scans if the surface is non-flat within the selection threshold.

14. The method of claim 11, further comprising:
determining the pose of the calibration LiDAR based on minimizing an error measurement calculation, the minimizing is performed via at least one of rotating and translating scans of the group of scans about the origin of the calibration LiDAR.

15. The method of claim 11, further comprising:
collecting a new group of scans upon the robot detecting a different surface using the calibration LiDAR and reference LiDAR; and
updating the average pose based upon the new group of scans of the different surface.

16. A system, comprising:
a non-transitory computer readable storage medium comprising a plurality of instructions embodied thereon; and
a controller configured to execute the computer readable instructions to,
receive a first measurement of a reference surface using a first LiDAR, the first measurement comprising a plurality of points;
receive a second measurement of the reference surface using a second LiDAR, the second measurement comprising a plurality of points;
select points of the second measurement within a selection threshold, the selection threshold comprising a spatial range orthogonal to measurement plane of the first LiDAR;
determine a first spatial transformation between selected points of the second measurement and points of the first measurement, the first spatial transformation configures the second LiDAR to localize the reference surface in a same location as the first LiDAR;
determine a pose of the second LiDAR based on the first spatial transformation; and
apply a digital filter to data arriving from the second LiDAR, the digital filter being based on the first spatial transformation;
wherein,
the determining the first spatial transformation is based on minimization of an error, the error comprising a Euclidian distance measurement between points of the second measurement and respective at least one closest point of the first measurement,
the reference surface is substantially orthogonal to a measurement plane of the first LiDAR, and
the first measurement and the second measurement are formed by grouping a number of individual scans from the respective first and second LiDARs, the number of individual scans being based on a group threshold.

17. The system of claim 16, wherein the controller is further configured to execute the computer readable instructions to:
calculate the pose of the second LiDAR upon subsequent measurement of the reference surface; and
calculate the pose of the second LiDAR upon subsequent measurement of surfaces substantially orthogonal to the measurement plane of the first LiDAR.

18. The system of claim 16, wherein the controller is further configured to execute the computer readable instructions to:
discard the number of individual scans and start collecting additional scans upon navigating near a new surface if the number of scans of the new surface does not exceed the minimum.
